(19) United States
(12) Patent Application Publication
(10) Pub. No.: US 2005/0099733 A1
(43) Pub. Date: May 12, 2005

(54) Flexible circuit and suspension assembly

(76) Inventor: Tracy M. Hagen, Edina, MN (US)

Correspondence Address: Sean D. Solberg, Esq.;DORSEY & WHITNEY LLP, Intellectual Property Department, 50 South Sixth Street, Suite 1500, Minneapolis, MN, 55402-1498, US

(21) Appl. No.: 10/967,630

(22) Filed: Oct. 18, 2004

Related U.S. Application Data
(60) Provisional application No. 60/512,506, filed on Oct. 17, 2003.

(51) Int. Cl. G11B 5/60

(52) U.S. Cl. 360/245.7

(57) ABSTRACT

The present invention relates to a flex suspension assembly. In one embodiment, the flex suspension assembly has a load beam and a flex circuit, wherein the flex circuit has a deformable, shape-retaining gimbal tongue. In another embodiment, the flex circuit has at least one protuberance associated with the gimbal tongue. In a further embodiment, the flex suspension assembly has a load beam, a flex circuit, and a mounting plate, and both the load beam and flex circuit have mounting plate holes, wherein the mounting plate is insertable through the mounting plate holes.

### CROSS-REFERENCE TO RELATED APPLICATION

This application claims priority to U.S. Provisional Application No. 60/512,506, filed Oct. 17, 2003, the content of which is incorporated in the entirety by reference.

### FIELD OF THE INVENTION

In the existing technology, a flexible suspension assembly (“FSA”) typically has a ring-type gimbal. Presumably, ring-type gimbals are used because they attach to the suspension at two points, whereas beam-type gimbals attach at one point. The two-point attachment, in theory, provides some degree of “limiter” capability.

### BACKGROUND OF THE INVENTION

In the existing technology, a flexible suspension assembly (“FSA”) typically has a ring-type gimbal. Presumably, ring-type gimbals are used because they attach to the suspension at two points, whereas beam-type gimbals attach at one point. The two-point attachment, in theory, provides some degree of “limiter” capability.

Significant problems with the ring-type gimbal FSA have contributed to the lack of commercial success. For example, the ring-type gimbal has a lack of robustness against shock, due to yielding in the copper conductors. Further, the existing gimbal requires a tiny amount of adhesive at one attachment point between the flex circuit and the load beam. In addition, there is a reduced working range of the gimbal in the existing technology relating to pitch and roll as a result of low dimple height and large gimbal area.

Additional disadvantages with the existing technology include a high variation in electrical impedance, thought to be due to irregular and sinuous conductor routing. Further, the existing gimbal is sensitive to temperature and humidity due to differences in expansion rates between polyimide, copper, and stainless steel. This sensitivity has driven the need for antenna-like appendages to the conductor lines to counteract expansion rate differences. In addition, the existing gimbal exhibits difficulty in measuring static attitude of the gimbal tongue due to laser light not reflecting from the polyimide surface and relatively little area of copper for light reflection.

Another disadvantage relates to the stiffness of the gimbal in the existing technology, which is approximately the same as conventional suspensions, even though the modulus of polyimide is significantly less than that of stainless steel. The existing assemblies lack in-plane stiffness, which results in poor tail alignment even when gimbal alignment is excellent. An additional disadvantage in the existing technology is the proximate routing of read and write conductor pairs, which degrades the quality of their performance. Further, the existing assemblies lack a ground plane in the body, further degrading the electrical signal quality. Additionally, the existing assemblies require exposure of the flex circuit to the manufacturing tooling, such as combing fingers, which can cause damage to the flex polyimide and the conductors themselves. In addition, the assymetric design of the existing flex circuit assemblies to route conductors around the mounting plate is an electrical disadvantage, because it can cause and conductance and impedance variations.

A further disadvantage with the existing technology relates to the mounting plate. Historically, the industry trend in mounting plate design has been towards a thinner, longer plate with increasingly complex geometries. The increased thinness is intended to reduce the size of disk drives. The reduction in thickness, however, has degraded the stiffness of the plate, resulting in pre-load change before and after ball swaging. The change in plate form after swaging can further adversely affect resonance and other critical properties of the suspension. Further, the increased length of the mount plate disadvantageously increases the sensitivity of critical suspension properties to plate flatness, as well as increasing actuator inertia. In addition, the historical trends in mounting plate design are driving the cost of new plate designs higher and higher.

Another disadvantage relates to the pre-load bend area of a suspension. The pre-load bend area is expected to act as a precision spring and a precision hinge. The problem is designing for these simultaneous roles, which can drive design compromises such that, in an attempt to approach both requirements, neither the spring nor hinge aspect is optimized. This can lead to manufacturing problems.

Yet another disadvantage relates to the load beam. A simple right angle bend is formed during the manufacturing process and used on the edges of most existing suspensions. Though it is easy to manufacture, it aggravates resonance control as the shear center, mass center, and neutral bending axis are all offset from each other. There is an effect, called “the Poisson effect” that introduces a lengthwise curvature to the load beam due to Poisson's ratio effect in the bend radius. This design has been found to be one of the least aerodynamic desirable designs, yet it continues to find use in high-speed drives.

There is a need in the art for a flexible circuit and suspension assembly that overcomes these disadvantages.

### SUMMARY OF THE INVENTION

The present invention, according to one embodiment, relates to a flex suspension assembly. The assembly includes a load beam and a flex circuit. The flex circuit has a deformable, shape-retaining gimbal tongue and at least one protuberance associated with the gimbal tongue. The protuberance is configured to be engageable with the load beam.

Alternatively, the present invention relates to a flex suspension assembly. The assembly has a load beam, a flex circuit, and a mounting plate. The load beam has a first mounting plate hole. The flex circuit has a second mounting plate hole. The mounting plate is configured to be insertable through the first and second mounting plate holes and has a circular flange configured to be attachable to the load beam.

In a further alternative, the present invention relates to a flex suspension assembly having a load beam and a flex circuit. The load beam has a pre-load spring. The flex circuit has a hinge.

### BRIEF DESCRIPTION OF THE DRAWINGS

FIG. 1A is a top view of a flex suspension assembly, according to one embodiment of the present invention.

FIG. 1B depicts a side view of a flex suspension assembly, according to one embodiment of the present invention.

FIG. 1C depicts a side view of a flex suspension assembly, according to one embodiment of the present invention.

FIG. 1D depicts a side view of a flex suspension assembly, according to one embodiment of the present invention.

FIG. 1E depicts a side view of a flex suspension assembly, according to one embodiment of the present invention.

FIG. 2A is a top view of a load beam, according to one embodiment of the present invention.

FIG. 2B depicts a side view of a load beam, according to one embodiment of the present invention.

FIG. 2C depicts a side view of a load beam, according to one embodiment of the present invention.

FIG. 2D depicts a side view of a load beam, according to one embodiment of the present invention.

FIG. 2E depicts a side view of a load beam, according to one embodiment of the present invention.

FIG. 3 depicts a top view of a load beam, according to an alternative embodiment of the present invention.

FIG. 4 depicts a top view of a flex circuit, according to one embodiment of the present invention.

FIG. 5 depicts a top view of a base portion, according to one embodiment of the present invention.

FIG. 6A depicts a top view of a ground portion, according to one embodiment of the present invention.

FIG. 6B depicts a top view of a plate, according to one embodiment of the present invention.

FIG. 7 depicts a bottom view of a base portion, according to one embodiment of the present invention.

FIG. 8 depicts a top view of conductors, according to one embodiment of the present invention.

FIG. 9A depicts a side view of a mounting portion, according to one embodiment of the present invention.

FIG. 9B depicts a top view of a mounting portion, according to one embodiment of the present invention.

FIG. 10 depicts a top view of a portion of a flex suspension assembly, according to one embodiment of the present invention.

FIG. 11 depicts a bottom view of a portion of a flex suspension assembly, according to one embodiment of the present invention.

### DETAILED DESCRIPTION

The present invention relates to an FSA having a beam-type gimbal. The present invention provides several advantages over the existing FSAs with ring-type gimbals. For example, pitch and roll stiffness analysis has shown the stiffness values to be significantly better for certain embodiments of the present invention than the ring-type flex gimbal suspension assembly or a conventional FSA. Further, the structure of the present invention according to certain embodiments provides for reduced alignment errors as a result of symmetric flex circuit and load beam fiducial holes about the suspension load point.

According to one embodiment, the present invention has a low profile reverse rail with a closed edge for better aerodynamic performance. Further, the load beam reverse rail in the gimbal region and merge comb regions according to one embodiment provides superior protection to the flex circuit. Improved UV tack curing is provided according to one aspect of the present invention as a result of horizontal adhesive fillets. Further, the apparatus of the present invention, according to some embodiments, exhibits high flex circuit in-plane stiffness for better tail alignment. Additionally, the device, according to one aspect of the present invention, is inherently highly damped, which reduces resonance amplitude more effectively than the damping achieved in the existing technology.

Another advantage of the present invention is the mounting plate. According to some embodiments, the mounting plate is a simple cylindrical solid that, in comparison to the existing technologies, reduces manufacturing costs and simplifies the assembly of the load beam; flex circuit, and mounting plate of the present invention.

In a further advantage, the structure of present invention, according to one embodiment, has a reduced size capable of supporting Femto size sliders without introducing significant manufacturing problems

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

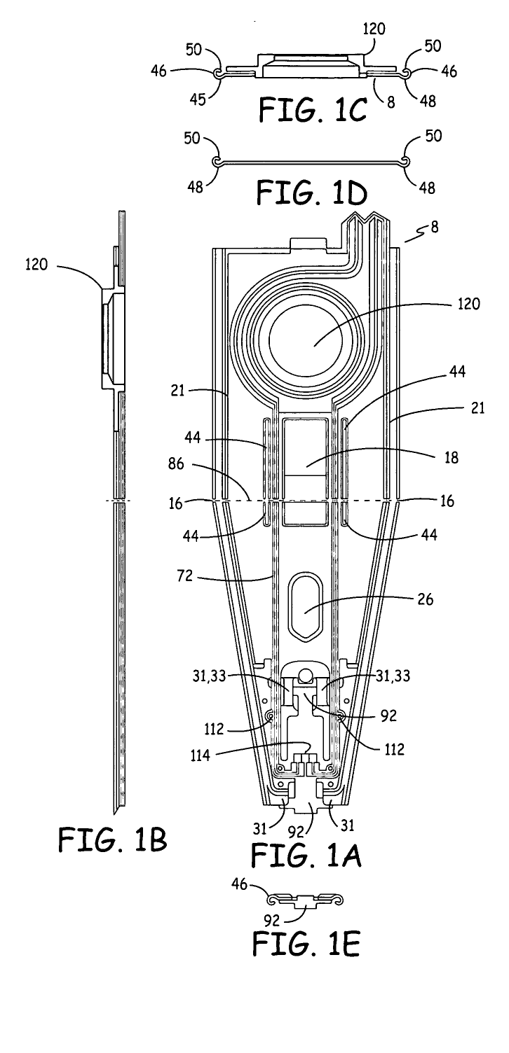

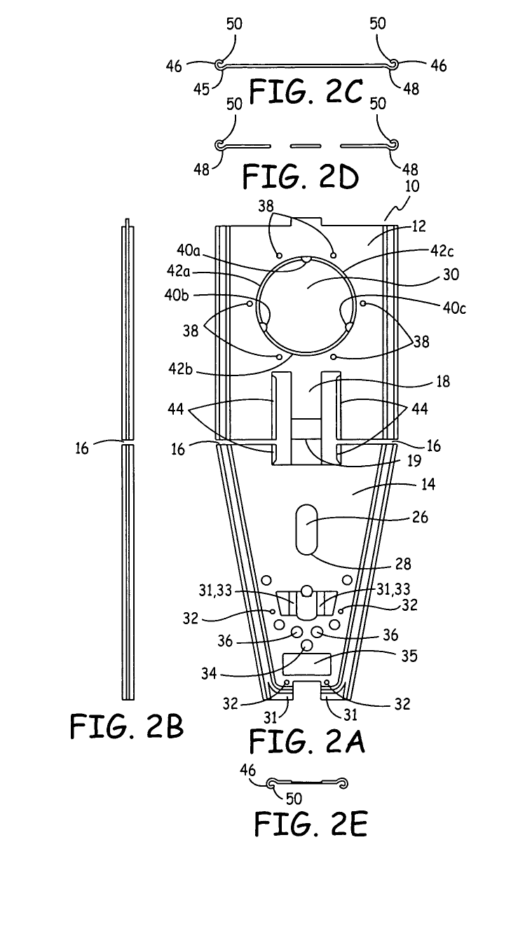

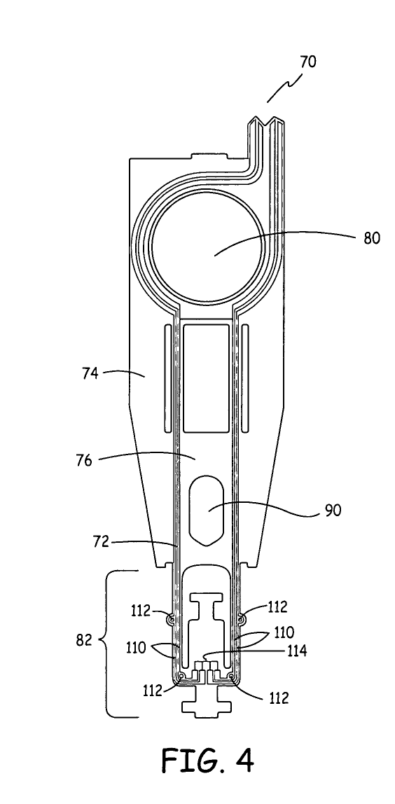

According to one embodiment, the present invention relates to a flex suspension assembly 8 as shown in FIG. 1A. The assembly 8 can include a load beam 10, as further shown in FIG. 2A, and a flex circuit 70 with conductors 72, as further shown in FIG. 4. In one embodiment, the flex circuit 70 is positioned on the load beam 10 and both are positioned such that a mounting portion 120 is inserted through holes in each of the flex circuit 70 and load beam 10, as shown in FIG. 1A.

During manufacture of an assembly 8 according to one aspect of the present invention that will be explained in further detail herein, a portion of the mounting portion 120 is inserted through a hole 30 in the load beam 10. Subsequently, the flex circuit 70 according to one embodiment is positioned adjacent to the load beam 10 and a portion of the mounting portion 120 passes through a hole 80 in the flex circuit 70.

According to one embodiment, the load beam 10 as depicted in FIGS. 2A, 2B, 2C, and 2D has a first or “mounting plate” portion 12 and a second or “gimbal” portion 14 separated by a space 16. The portions 12, 14 are connected by a connection element 18 (which will also be referred to herein as a “beam” or “spring”) which is defined in part by rectangular openings 20 on either side of the beam 18. As can be best seen in FIG. 2A, the load beam 10 also has a rectangular opening 22, a set of two gimbal connection elements 24 (which will also be referred to as “gimbal beams”), an opening 26 (hereinafter also referred to as a “tooling slot”) with a “V” shape 28 formed in the opening 26, and a generally round opening 30. The V has an angle, according to one embodiment, of 120 degrees. According to one embodiment, spring loaded pins are used with respect to the tooling slot 26. The space 16, according to one embodiment, is actually two small trapezoidal half-etched recesses 16 in the load beam 10. Having a space 16 at this location can eliminate lifting of the flex circuit.

Further, the load beam 10 has four small holes 32, a load point dimple 34, two viewing holes 36, a generally rectangular opening 35, and six small holes 38 positioned around the opening 30. The opening 30 has three contact elements 40a, 40b, 40c that protrude toward the center of the opening 30 and three curved flanges 42a, 42b, 42c positioned between the contact elements. In one embodiment, the load beam 10 also has bent portions 44 on the edges of the load beam 10 that border on the openings 20 on either side of the beam 18. FIG. 2B depicts a side view of the load beam of FIG. 2A. According to one embodiment, the placement of the dimple 34 can vary. For example, the dimple 34 can be placed at various locations depending on specific product applications.

As shown in FIGS. 2C and 2D, the load beam 10 according to one embodiment has outer edges that are formed or bent into a folded configuration 46 (also known as a “closed V rail”). The folded configuration 46, according to one embodiment, has three folds that create a recess 48 and a closed portion 50.

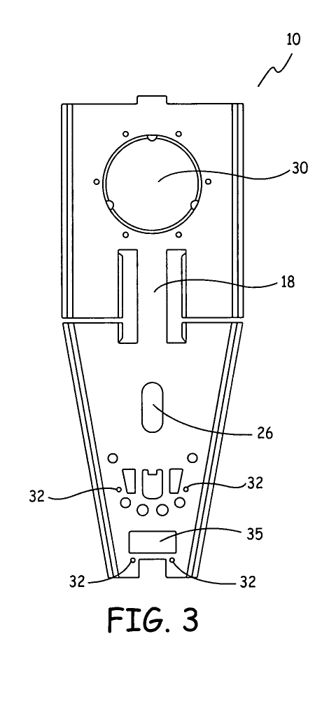

FIG. 3 depicts a load beam 10 according to an alternatively embodiment of the present invention that does not include a folded configuration.

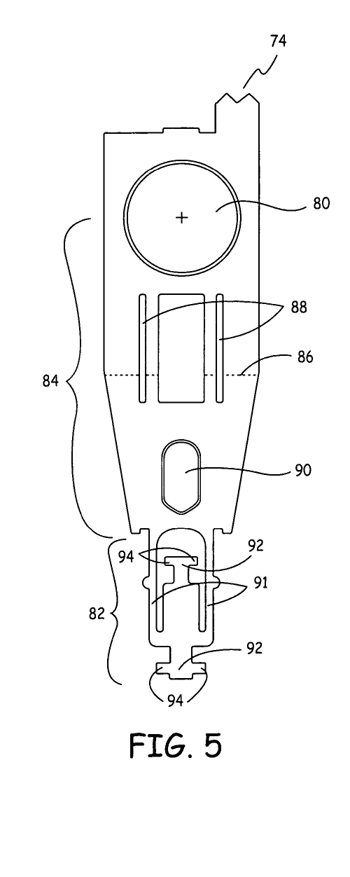

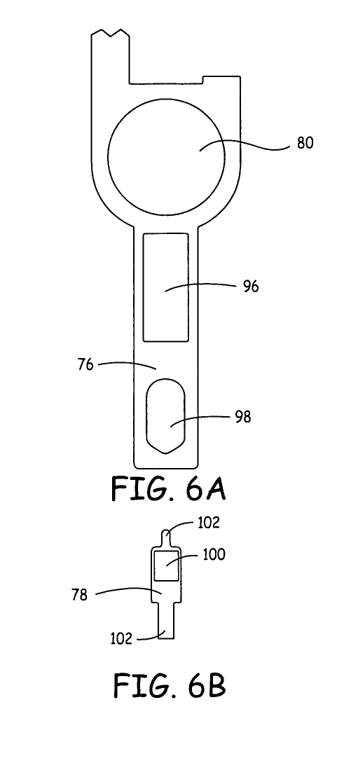

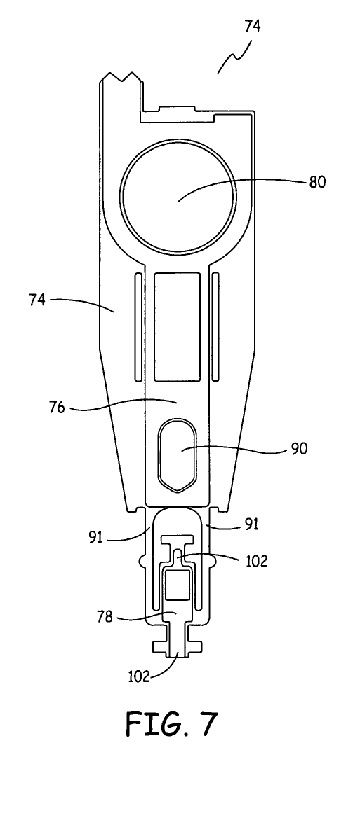

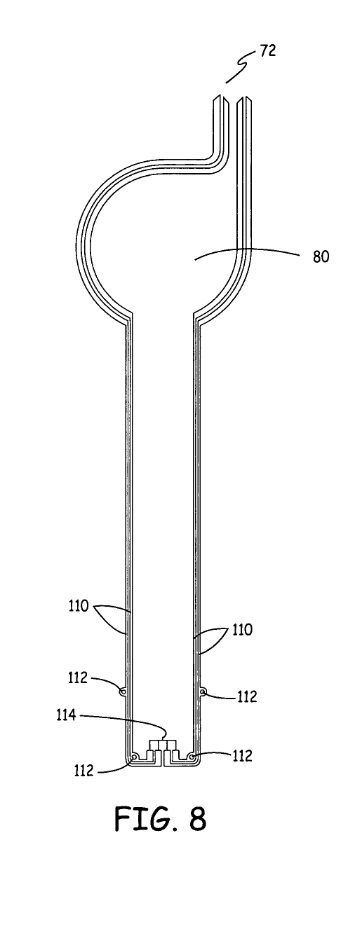

FIG. 4 depicts a flex circuit 70 with conductors 72, according to one embodiment of the present invention. The flex circuit 70 can, in one aspect of the invention, be positioned on the load beam 10 as shown in FIG. 1. The flex circuit 70 in this embodiment includes a base portion 74, as further shown in FIG. 5. According to one embodiment, the base portion 74 is polyimide. A ground portion 76 (also referred to as an “electrical ground plane”) and a plate 78 (also referred to as a “gimbal plate”) as shown in FIG. 6 can be positioned on the base portion 72 as shown in FIGS. 4 and 7. According to one embodiment, the ground portion 76 and gimbal plate 78 are positioned such that when the flex circuit 70 is positioned on the load beam 10, the ground portion 76 and gimbal plate 78 are positioned between the flex circuit 70 and the load beam 10. Further, the conductors 72 as shown in FIG. 8 can be positioned on the flex circuit 70 as shown in FIG. 4. The gimbal plate 78, in one aspect of the invention, is formable and malleable without cracking. According to one embodiment, the gimbal plate 78 is copper.

FIGS. 4 and 5 depict the base portion 74. The base portion 74 has a tongue portion 82 (also referred to herein as a “gimbal portion” or “gimbal tongue”) and a body portion 84. The body portion includes a hole 80 that corresponds to the hole 30 in FIG. 2A, a hinge 86 (also referred to herein as the “pre-load bend area”), two openings 88 that intersect with the hinge 86, and an opening 90 that corresponds to the tooling slot 26 in FIG. 2A. The tongue portion 82 has two beam portions 91 (also referred to as gimbal beams) and two contact portions 92 (also referred to as “t-shaped protuberances”). Each contact portion 92 has two tab portions 94. According to one embodiment, no overcoat is used in the pre-load bend area 86 or body portion 84.

FIGS. 6 and 7 depict the ground portion 76 and the gimbal plate 78. FIG. 7 depicts the bottom portion of the base portion 74. The ground portion 76 defines a hole 80 that corresponds to the hole 30 in FIG. 2A, a rectangular opening 96, and an opening 98 that corresponds to the tooling slot 26 in FIG. 2A. According to one embodiment, the ground portion 76 extends up to the gimbal beams 91. The gimbal plate 78 defines a rectangular opening 100 and two extension portions 102. The gimbal plate 78 is positioned on the base portion 74 as depicted in FIG. 7.

FIG. 8 depicts the conductors 72 according to one embodiment of the present invention. The conductors 72 include linear conductor lines 110 and holes 112 that allow for use with fasteners to attach the conductors 72 to the flex circuit 70 as shown in FIG. 4. The conductors also have pads 114 (hereinafter also referred to as “slider bond pads”). In one aspect of the present invention, the linear conductor lines 110 are straight and widely separated.

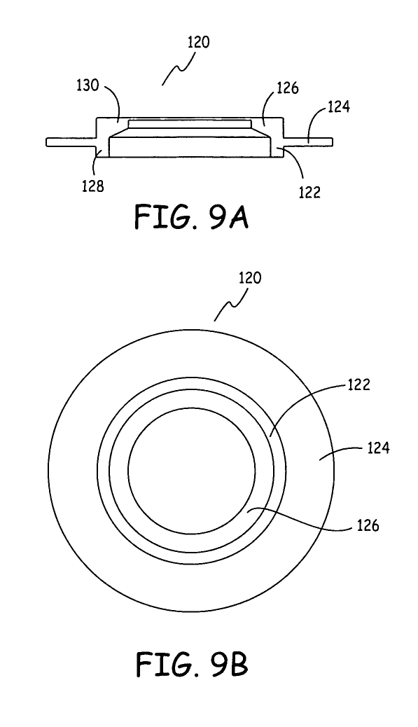

FIGS. 9A and 9B depict the mounting portion 120 (also referred to as a “mounting plate”). The mounting portion 120 has an assembly receiving portion 122 (also referred to as a “stiffening ring”), a circular flange 124, and an attachment collar 126. The stiffening ring 122 protudes axially away from the flange 124 in the direction opposite of the swage boss 126. In one embodiment, the mounting plate 120 is a simple cylindrical solid. The plate 120 can be manufactured by either stamping or turning. The mounting portion 120 is configured to receive a flex suspension assembly 8 of the present invention by insertion of the stiffening ring 122 into the hole 30 in the flex suspension assembly 8 as shown in FIGS. 1A and 1B and subsequent contact and/or attachment between the load beam 10 and the circular flange 124. The circular flange 124 replaces a conventional plate in the existing technology. According to one embodiment, the attachment collar 126 is a swage plate boss 126 wherein the method of attachment is swaging.

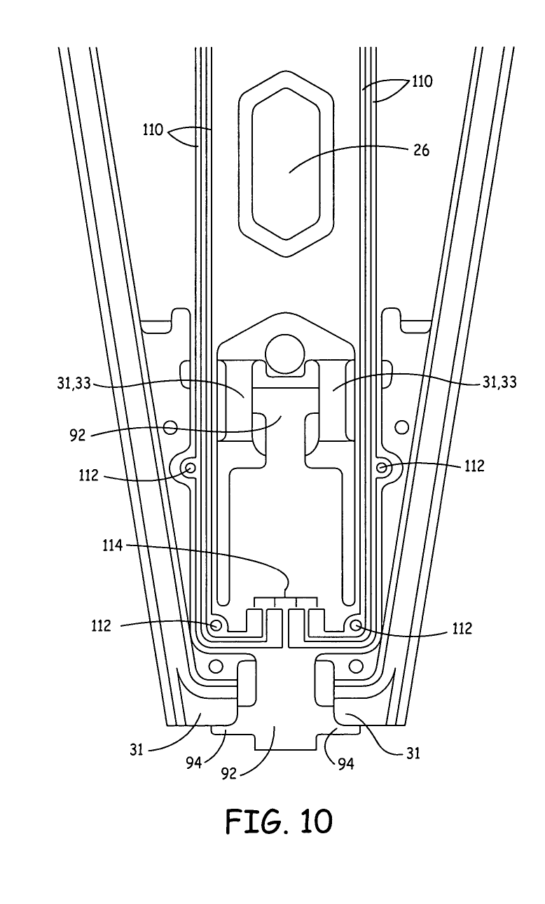

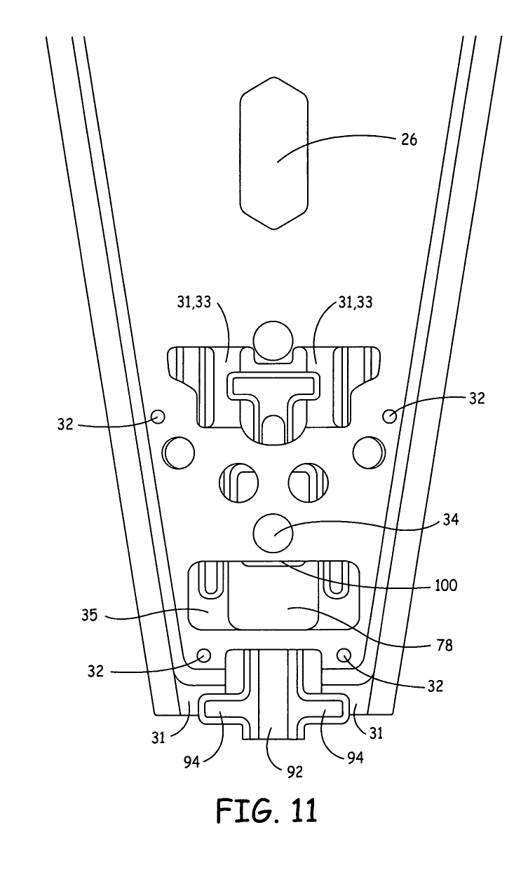

Returning to FIG. 1, the flex circuit 70 is positioned on the load beam 10 in the following manner, according to one embodiment of the present invention. The protuberances 92 of the flex circuit 70 contact or engage with the load beam 10 at four contact portions 31, wherein two of the contact portions are contact beams 33. More specifically, the tab portions 94 of the protuberances 92 contact or engage with the contact portions 31 of the load beam 10. This can be seen in further detail in FIGS. 10 and 11. This engagement or association between the flex circuit 70 and the load beam 10 provides out-of-plane movement restriction, thus allowing some freedom of motion, but limiting the motion of the flex circuit relative to the load beam. During assembly, the tabs 94 fold up and then spring out after proper placement in association with the load beam 10. This can be accomplished primarily due to the high resistance of the base portion 74 (which, according to one embodiment, is polyimide) to “taking a set.” Polyimide has a high yield stress to modulus ratio, making it quite resistant to permanent deformation. That is, polyimide can be manipulated or bent, and upon release, the polyimide will typically snap back to its original shape. Alternatively, any known material that has a similar resistance to “taking a set” can be used in place of the polyimide.

According to one embodiment, this engagement or association between the flex circuit 70 and the load beam 10, unlike existing flex gimbal suspension assembly and FSA designs, does not require any adhesive in the gimbal area. This can result in significantly improved manufacturing yields.

According to one embodiment, it is desirable to have the two contact portions 92 formed or bent slightly down away from the load beam 10 after insertion. Having the contact portions 92 bent downward (away from the load beam 10) allows for the flex suspension assembly 8 of the present invention to have free movement in the pitch and roll direction without the need to form clearance-providing features in the suspension (which take away from suspension to disk clearance). That is, the bend in the contact portions 92 away from the load beam 10 allows the slider or read/write head (not shown) to move in the pitch and roll direction on the dimple 34. According to one embodiment, the forming angle of the extensions 102 on the gimbal plate 78 is approximately 20 degrees. To further provide forming ability or malleability without brittleness, the extensions 102 of the gimbal plate 78, as depicted in FIGS. 6B and 7, allow easy forming as a result of the copper, which has a low yield stress to modulus ratio.

As can be best seen in FIG. 11, when the flex circuit 70 is positioned on the load beam 10, according to one embodiment, the opening 100 in the gimbal plate 78 under the gimbal tongue 82 of the flex circuit 70 is located where the dimple 34 on the load beam 10 contacts the gimbal tongue 82. The opening 100, according to one embodiment, also allows for inspection of the slider (not shown) to gimbal adhesive bond through the viewing holes 36 in the load beam 10.

In a further aspect of the present invention, the gimbal plate 78 extends over the region below the pads 114 of the conductors 72, for the following reason. The generally rectangular opening 35 in the load beam 10 in the region of the pads 114 on the conductors 72 provides ball-bond termination fixture support (allows ball-bond tool to contact through the opening). Placing copper in this region provides a large surface for laser light reflection, thus enabling pitch and roll measurement to be made at the flex circuit level with current metrology systems. This can be advantageous for flex circuit manufacturing process control. In one alternative embodiment, some systems may require new receivers to take advantage of this feature.

As can be seen in FIGS. 1A, 2A, and 4, according to one aspect of the present invention, the four holes 112 in the conductors 72 are aligned with four similar holes 32 in the load beam 10. In accordance with one embodiment, these holes 112, 32 are, in the longitudinal direction, equidistant from the dimple 34 shown in FIG. 2A. This arrangement reduces the sensitivity to absolute calibration of the vision system for accurate alignment of the flex circuit 70 to load beam 10 alignment.

FIGS. 1A, 4, and 8 depict the linear conductor lines 110 of the conductors 72. These lines 110, according to one embodiment, can improve the impedance quality of the circuit. According to one embodiment, the widths and spaces of the lines 110 is 0.002-inch. Given these dimensions, the flex circuit 70 according to an alternative embodiment could be easily modified to add a third conductor line.

According to one embodiment, each of the contact beams 33, as shown in FIGS. 1A, 2A, 10, and 11, can have a bend (not shown). The bend in each beam 33 addresses dimple separation concerns. In one embodiment, the bend oriented transverse to the gimbal and is approximately one-third along the length of the beam 33 from the end of the beam 33 closest to the space 16 in the load beam 10. By locating the bend approximately one-third from that end of the beam 33, the angle of the gimbal tongue 82 while the suspension assembly 8 of the present invention is in the loaded state is relatively insensitive to the bend angle in the beam.

FIGS. 2A and 3 depict the load beam 10, according to one embodiment of the present invention. As mentioned above, the load beam 10 is configured to associate with or attach to the stiffening ring 122 of the mounting plate 120. In one embodiment, the load beam 10 of FIG. 2A is symmetric about the centerline running from the center of the hole 30 through the center of the dimple 34.

In accordance with one embodiment, the connection element 18 of the load beam 10 is approximately twice as long as a conventional connection elements in conventional 11 mm suspension designs. For example, according to one embodiment, the beam 13 is about 3 mm. According to one embodiment, the connection element 18 is a single pre-load force supplying beam 18. The extra length of the beam 18 can significantly reduce the out-of-plane stiffness of the conductor lines in this area, thereby enabling the use of a ground portion 76 with negligible stiffness penalty.

In one aspect, the load beam 10 of the present invention provides protection for the flex circuit 70 from combing fingers and like tooling.

According to one embodiment, the holes 32 in the load beam 10 are about equidistant in the longitudinal direction from the load beam dimple 34. This can significantly reduce the sensitivity of alignment to vision system calibration according to one embodiment. The load beam 10 and holes 32 have, according to one embodiment, large wheelbases, which can assist in automating an assembly line.

As shown in FIGS. 2A and 3, the three tabs 40a, 40b, 40c on the load beam 10 are designed, in accordance with one embodiment, such that the surfaces of the tabs 40a, 40b, 40c closest to the center of the hole 30 are on a circle slightly smaller than the outer diameter of the stiffening ring 122 of the mounting plate 120. When the stiffening ring 122 is inserted through the load beam 10, the three tabs 40a, 40b, 40c contact or “barb into” the stiffening ring 122, thereby strengthening the association of the load beam 10 and the stiffening ring 122 or creating resistance to removal of the stiffening ring 122. The barb action also provides firm contact between the load beam 10 and mounting plate 120 for electrical ground paths. Moreover, the barb action provides a self-alignment value, eliminating the need for precision alignment tooling. The tabs 40a, 40b, 40c can be half-etched to improve their ability to bend during stiffening ring 122 insertion.

According to one embodiment of the load beam 10, the three flanges 42a, 42b, 42c associated with the hole 30 can also be half-etched. In accordance with one aspect of the invention, the flanges 42a, 42b, 42c have been formed at approximately a 45-degree angle up. After forming, the inside diameter of the flanges 42a, 42b, 42c is slightly larger than the outside diameter of the stiffening ring 122. The flanges 42a, 42b, 42c, according to one embodiment, are provided to ease the initial insertion of the stiffening ring 122. The flanges 42a, 42b, 42c, having been formed 45 degrees upward, provide additional surface area for adhesive bonding. During flex circuit 70 attachment, the adhesive may be extruded from the flex circuit 70 due to squeezing and flow through the gap between the load beam 70 and the stiffening ring 122. The radiused base of the flanges 42a, 42b, 42c is designed to enhance adhesive flow between the load beam 10 and mounting plate 120.

Further, the six holes 38 according to one embodiment, can provide additional introduction paths for adhesive flow between load beam 10 and the flex circuit 70.

According to one embodiment, the adhesive is a UV-thermal curable adhesive. For example, the adhesive may be from the Emcast® family of products of Electronic Materials Inc. of Breckenridge Colo. According to one embodiment, a conductive adhesive is applied to provide an electrical ground path between the flex circuit 70 ground portion 76 and the suspension assembly 8. In accordance with one embodiment, the conductive adhesive is applied around the tab 23a. Conductive adhesive escaping from this location as a result of squeezing would readily flow through the gap between the load beam 10 and the mounting plate 122, providing a requisite ground path. The conductive adhesive can be, for example, Ablebond 8385 a product of AbleStik of Rancho Dominguez, Calif. a National Starch & Chemical company.

According to one embodiment, the flex suspension assembly 8 of the present invention as depicted in FIG. 1A has separate elements that perform as a spring 18 and a hinge 86. As a result, the designing tension associated with existing technologies is avoided. This can yield a significantly expanded optimization space that results in suspensions with unique characteristics.

With respect to the spring 18, the single, centrally located beam 18 in the load beam 10, according to one embodiment of the present invention, serves as the pre-load spring 18, as shown in FIGS. 1A, 2A, and 3. Since it does not serve as a hinge, the spring 18 can be designed to optimize its spring function. According to one embodiment, the significantly increased length of the beam 18 relative to a conventional FSA, from about 1.5 mm to about 3 mm, as further discussed herein, reduces the vertical spring constant of the assembly. This produces a 20 to 30 percent reduction in the FSA spring constant, according to one embodiment, without increasing the load stress. According to one embodiment, the force in the loaded state is all transmitted down the center of the load beam, directly to the flange of the mounting plate.

Further, the single beam 18 for pre-load, according to one embodiment, can simplify pre-load adjust substantially. That is, only one pair of lasers is required (top-side and bottom-side—it's possible to up-gram as well as down-gram suspensions by using lasers), plus the beam 18 is much wider and thus easier for laser aiming.

The hinge 86, according to one embodiment of the present invention, is provided by the base portion 74 of the flex circuit 70, as shown in FIG. 5. In some embodiments, the base portion 74 is polyimide, and because polyimide has a Young's modulus approximately 3 percent that of stainless steel, the hinge 86 according to one embodiment need not be very long to provide good flexibility. Analysis indicates that a polyimide hinge 86 length of about 0.005 inches will be more than adequate for low vertical spring constant.

According to one embodiment, the hinge 86 is located at the instant center of rotation of the body region 84 of the base portion 74 relative to the region of the base portion having the hole 80. At this location, the hinge 86 is in a pure bending mode, and not displaced out-of-plane. Assuming the suspension's loaded state is nearly flat, there is theoretically no bending force or moment in the polyimide hinge 86, thus no need to extend the mounting plate 120 to these points.

According to one aspect of the present invention, the FSA 8 of the present invention has two elements in the compliant length of the structure. In addition to the beam 13, the assembly 8 also has a pair of beams 33 disposed about the longitudinal centerline of the apparatus. According to one embodiment, the start points and end points for each of these element are selected to result in instant centers for each element that are coincident. Making each element symmetric to the other can result in nearly coincident instant centers (“I.C.s”).

According to one embodiment, the load beam 10 instant center of rotation described above provides performance improvement with respect to resonance characteristics. That is, this design will realize first bending and first torsion mode frequencies significantly greater than any previous achievement. The first bending and first torsion resonance in suspensions, for the most part, are problems where the body region of the suspension rotates in a rigid body fashion, resisted by the out-of-plane stiffness of the region around the hinge 86. In first bending, the body portion 84 rotates about the dimple 34 on a transverse axis, and in first torsion, the body region 84 rotates about the dimple 34 on the longitudinal axis.

It is known in the art that the resistance to the body region 84 rotations comes from the out-of-plane stiffness of the region around the hinge 86. In the set of suspension design formulas are equations for estimating first bending and first torsion frequencies, derived using Rayliegh's Method. According to one embodiment of the present invention, the very significant reduction in length of the region around the hinge 86 yields overall an order of magnitude increase in out-of-plane stiffness. This design will realize first bending and first torsion mode frequencies significantly greater than anything in the existing technology.

The sway mode frequency according to one embodiment of the present invention is between 10 and 15 kHz. Further, polyimide provides significantly better damping than stainless steel and thus greatly attenuates the sway mode amplitude.

According to one embodiment, the load beam 10 of the present invention features a bend 19 for pre-load forming as shown in FIG. 2A. There is no need for graceful roll forming with this design, since the load beam 10 does not provide the hinge 86 function. According to one embodiment, it may be advantageous to do the laser gram adjust at the length position of the instant center. Pre-load forming to two bends and leaving an undisturbed surface available for laser gram adjust would accomplish this.

FIGS. 9A and 9B depict the mounting plate 120 and FIG. 1A depicts the flex suspension assembly 8 mounted on the mounting plate 120, according to one embodiment of the present invention. As discussed above, during manufacture of an assembly 8 according to one aspect of the present invention, the stiffening ring 122 is inserted through a hole 30 in the load beam 10, as shown in FIGS. 2A and 3. Subsequently, the flex circuit 70 according to one embodiment is positioned on the load beam 10 and the stiffening ring 122 passes through a hole 80 in the flex circuit as shown in FIGS. 4, 5, and 7. According to one embodiment, eliminating the extended plate features of a conventional plate and substituting a flange 124 for attachment of the load beam 10 can substantially reduce the deformation at the attachment point between plate and boss at the point where the load beam 10 attaches to the mounting plate 120.

According to one embodiment, the stiffening ring 122 protrudes through the assembly 8 at the hole 30 in the load beam 10 and the hole 80 in the flex circuit 70 by approximately 0.001 inches. This can provide a solid surface for clamping during ball swaging, thereby protecting the flex circuit 70. Alternatively, the ring 122 protrudes through the assembly 8 by any known amount.

The top surface 128 of the stiffening ring 122, in accordance with one aspect of the present invention, can serve as a surrogate datum reference during pre-load and static attitude measurement. By controlling the distance from the top 128 of the stiffening ring 122 to the bottom surface 130 of the plate 120 (thickness) and the parallelism of surfaces 128 and 130, receivers used in pre-load and static attitude measurement can be simplified in design and ease of use to the point where automated equipment can be used on the single part level. In contrast, existing designs are complex to the point where human operators are a required necessity to load and unload parts from pre-load and static attitude measurement systems.

The apparatus of the present invention, according to one embodiment, eliminates laser welding during assembly. By eliminating this process, the selection of materials available for suspensions is broadened greatly. For example, the material could be Beryllium Copper, Titanium, Aluminum, laminates, and even certain plastics. According to one embodiment, aluminum is a useful material because it has a low modulus and low density, which can significantly reduce actuator inertia, improve actuator arm resonance, and improve shock resistance.

FIGS. 2C, 2D, and 2E depict the “closed V-rail” 46, according to one embodiment of the present invention. The closed V-rail 46, according to one embodiment, is an inverted V-rail that has been modified by adding a third bend that closes the rail on itself. In comparison to the existing technologies (including an inverted V-rail), this closed V-rail 46 adds additional rigidity and improved aerodynamics to the load beam 10 with no increase in height of the rail. For comparison, the overall height of a typical FSA in the rail area is about 0.015 inches, while, according to one embodiment, the height of an FSA of the present invention is just 0.011 inches.

The closed V-rail 46, according to one aspect of the present invention, provides a recess 48 for the flex circuit 70, reducing the overall exposed area for aerodynamic forces. The recess 48 created by the closed V-rail 46 can protect the flex circuit 70 from damage during suspension assembly and subsequent manufacturing processes. This eliminates the need for an overcoat, which is a source of deformation to the flex circuit 70 during manufacturing. In addition, according to one embodiment, the closed V-rails 46 extend the length of the FSA of the present invention, providing protection to the flex circuit 70 from handling damage.

It would be readily apparent to one of ordinary skill in the art how easily this apparatus, according to one embodiment, can be modified to provide a lifting ramp for load/unload applications. According to one embodiment, in fact, the apparatus can operate adequately for load/unload with no modification whatsoever.

According to one embodiment, the closed V-rail 46 requires at least three die cavities. To ease the forming of the closed section, a half-etch line can be provided in the load beam 10.

As shown in FIG. 1A, the outer edge 11 of the flex circuit 70, according to one embodiment of the present invention, is designed to be coincident with the start of the closed V-rail 46 configuration. This arrangement can cause squeezed-out adhesive to form a horizontally-oriented fillet. According to one embodiment, the horizontal orientation is advantageous, because the UV-curing light is oriented vertically. This can improve the effectiveness of UV-tacking. Similarly, according to one embodiment, this concept can also be realized on the bent portions 44 near the hinge 18. Again, adhesive in this area is dammed by an outer vertical edge, creating a horizontal exposed fillet more readily curable by UV light.

In one aspect of the present invention, the flex suspension assembly 8 is wide in the portion of the assembly 8 surrounding the space 16 and hinge 86, as shown in FIG. 1A. This wide section of the assembly 8 can significantly enhance the in-plane rigidity of the assembly 8, thereby improving the tail alignment quality.

Certain embodiments of the present invention exhibit a moderate vertical spring constant of about 44 grams per inch and further embodiments exhibit a moderate load beam bending stress of about 29,700 psi per gram.

Some typical specifications for manufacturing purposes, according to one embodiment of the present invention, include 11 mm length, swage hole 18 centerline to dimple 35 centerline, a load beam thickness of 0.002 inches, a polyimide thickness of 0.001 inches, a copper thickness of 0.0006 inches, a trace width of 0.002 inches, a trace spacing of 0.002 inches, and a Pico slider.

Although the present invention has been described with reference to preferred embodiments, persons skilled in the art will recognize that changes may be made in form and detail without departing from the spirit and scope of the invention.

1. A flex suspension assembly comprising:
(a) a load beam; and
(b) a flex circuit comprising:
(i) a deformable, shape-retaining gimbal tongue; and
(ii) at least one protuberance associated with the gimbal tongue, the at least one protuberance configured to be engageable with the load beam.

2. The assembly of claim 1 wherein the gimbal tongue comprises a polyimide material.

3. The assembly of claim 1 further comprising a ground plane associated with the gimbal tongue, the ground plane configured to provide some deformation retention.

4. A flex suspension assembly comprising:
(a) a load beam having a first mounting plate hole;
(b) a flex circuit associated with the load beam, the flex circuit having a second mounting plate hole; and
(c) a mounting plate configured to be insertable through the first and second mounting plate holes, the mounting plate having a circular flange configured to be attachable to the load beam.

5. A flex suspension assembly comprising:
(a) a load beam having a pre-load spring; and
(b) a flex circuit associated with the load beam, the flex circuit having a hinge.
